(19) United States
(12) Patent Application Publication
(10) Pub. No.: US 2002/0194090 A1
(43) Pub. Date: Dec. 19, 2002

(54) Method and system for obtaining information utilizing user interfaces

(76) Inventors: David John Gagnon, Avon, OH (US); Ajay Joshi, Fort Wayne, IN (US); Norm Sowards, Canton, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,867

(22) Filed: Jun. 19, 2001

(51) Int. Cl. G06F 17/60

(52) U.S. Cl. 705/27

(57) ABSTRACT

A method is provided for communicating business information using a network-based system. The system including at least one server coupled to a database and at least one device. The method including creating a plurality of dashboards, storing the dashboards in the database, populating the dashboards using information from the database, and providing the dashboards to a user through the device.

### COPYRIGHT STATEMENT

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

This invention relates to computer network-based communication systems, and more particularly, to computer network-based methods and systems for managing business information.

Many large organizations have difficulty communicating with customers. For example, organizations that have widely dispersed customers or customers with multiple managers working on the same account or project typically have difficulties measuring performance information and monitoring current trends. In addition, it is sometimes difficult for customers to monitor the performance and current status that relate to the business objectives set forth by an organization. Further, each manager typically has a separate reporting system, leading to divergent approaches and a sometimes an unwieldy administrative process leading to a reduced flow of information up and down the customer-supplier relationship and imposing a cost in time, efficiency, and potentially performance.

### SUMMARY OF INVENTION

In one aspect, a method is provided for communicating business information using a network-based system. The system including at least one server coupled to a database and at least one device. The method comprising creating a plurality of dashboards, storing the dashboards in the database, populating the dashboards using information from the database, and providing the dashboards to a user through the device.

In another aspect, a system is provided for communicating business information. The system comprising at least one device, at least one server configured to receive business information, store the business information and provide the business information, and a network connecting the at least one server to the at least one device. The server configured to generate at least one dashboard using the business information. The dashboard available through the network for display on the device.

In another aspect, a system is provided for communicating business information. The system comprising at least one device, at least one server configured to receive business information, store the business information and provide the business information, and a network connecting the at least one server to the at least one device. The at least one dashboard comprising at least one dial comprising a graphic display of the business information and a drilldown data display. The dashboard generated by the server using the business information. The dashboard stored on the server after generation. The dashboard selectively available through the network for display on the device.

In another aspect, a computer program is provided that is embodied on a computer readable medium. The computer program is for managing business information. The program comprising a code segment that receives business information and then maintains a database by adding, deleting and updating business information, generates at least one dashboard based on the received business information, and provides consistent dashboards to users.

### BRIEF DESCRIPTION OF DRAWINGS

FIG. 1 is a block diagram of an Automated Customer Dashboard System (ACDS) in accordance with one embodiment of the present invention.

FIG. 2 is an expanded version block diagram of an exemplary embodiment of a server architecture for the system shown in FIG. 1.

FIG. 3 is a block diagram of an alternative embodiment of an exemplary server architecture for the system shown in FIG. 1.

FIG. 4 is a schematic diagram of an exemplary database configuration for the system shown in FIG. 1.

FIG. 5 is a flow diagram of a method for accessing information utilizing a user interface.

FIG. 6 is a flow diagram of the dashboard creation process.

FIG. 7 is an exemplary embodiment of an interactive ACDS login user interface.

FIG. 8 is an exemplary embodiment of an ACDS main user interface.

FIG. 9 is an exemplary embodiment of a Dashboard Template Selection user interface.

FIG. 10 is an exemplary embodiment of a Dashboard Title user interface.

FIG. 11 is an exemplary embodiment of a Customer List user interface.

FIG. 12 is a continuation user interface of the Customer List user interface shown in FIG. 9.

FIG. 13 is an exemplary embodiment of a Dial Information user interface.

FIG. 14 is an exemplary embodiment of a Dial Owner user interface.

FIG. 15 is an exemplary embodiment of a Viewer user interface.

FIG. 16 is an exemplary embodiment of a Preferences user interface.

FIG. 17 is an exemplary embodiment of the ACDS main user interface shown in FIG. 8 including a newly created dashboard.

FIG. 18 is an exemplary embodiment of the ACDS main user interface shown in FIG. 8 after generation of the dashboard shown in FIG. 17.

FIG. 19 is an exemplary embodiment of the dashboard shown in FIG. 18, including a dial.

FIG. 20 is an exemplary embodiment of a drilldown data display of the dial shown in FIG. 19.

FIG. 21 is an exemplary embodiment of a dashboard including six dials.

### DETAILED DESCRIPTION

Exemplary embodiments of systems and processes that facilitate integrated network-based electronic reporting and workflow process management related to an Automated Customer Dashboard System (ACDS) are described below in detail. The systems and processes facilitate, for example, electronic reporting of information via a user interface, filtering business information, automated report generation and network-based delivery for customer review and process improvement.

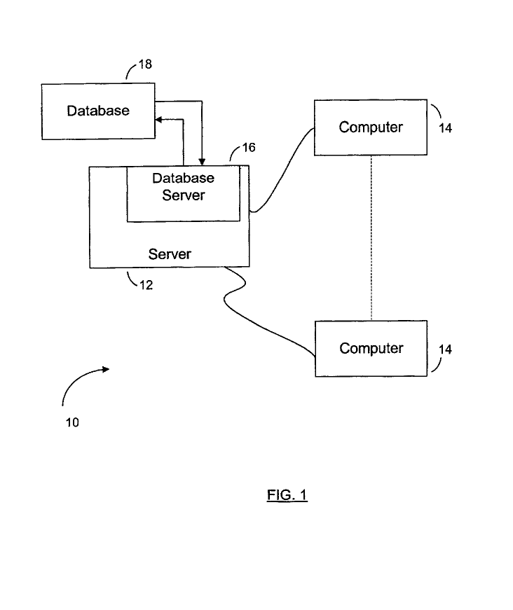

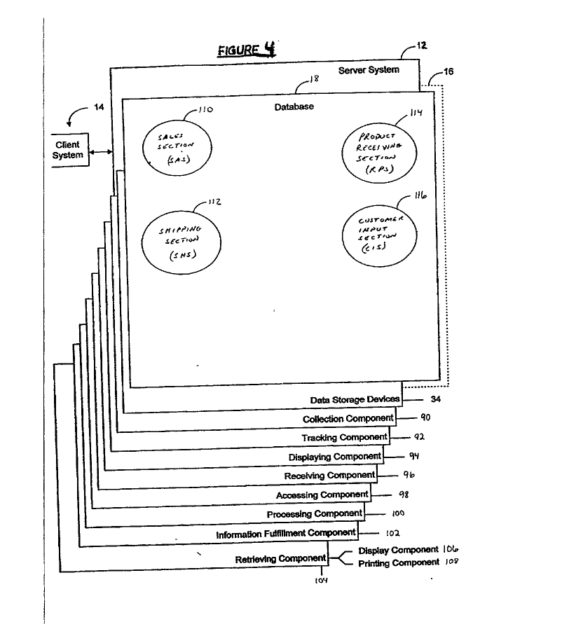

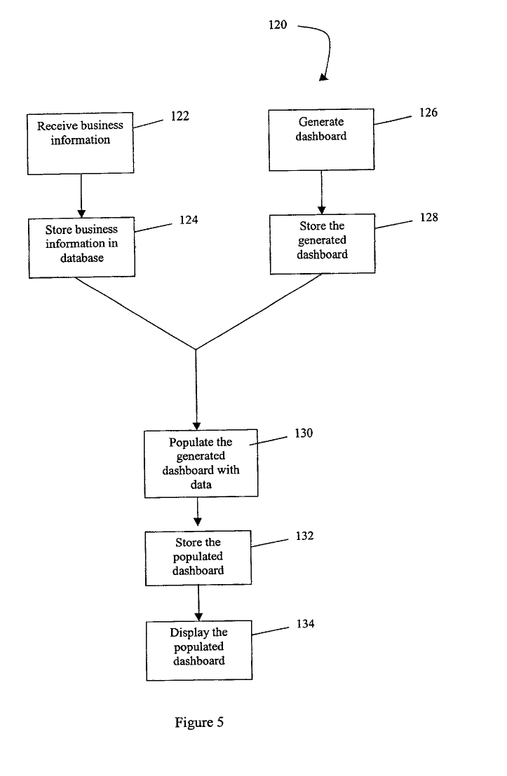

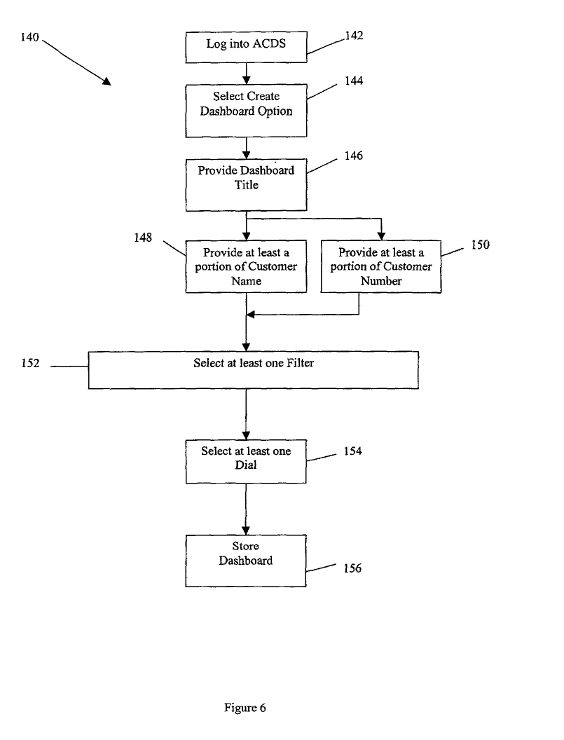

Set forth below are details regarding exemplary hardware architectures (FIGS. 1-3), an exemplary database configuration (FIG. 4), an exemplary process flow chart illustrating a process for accessing various types of information (FIG. 5), and exemplary screen shots (FIGS. 6-21) displayed by the exemplary system to a user desiring to create and use a user interface configured as a dashboard. Although specific exemplary embodiments of methods and systems for managing information utilizing user interfaces configured as dashboards are described herein, the methods and systems are not limited to such specific exemplary embodiments. Components of each system and each process can be practiced independent and separate from other components and processes described herein. Each component and process also can be used in combination with other components and processes.

FIG. 1 is a block diagram of an Automated Customer Dashboard System (ACDS) 10 in accordance with one embodiment of the present invention. ACDS 10 includes a server sub-system 12 and a plurality of user devices 14 connected to server sub-system 12. Server sub-system 12 is sometimes referred to herein as server 12. In one embodiment, devices 14 are computers including a web browser, and server 12 is accessible to devices 14 via a network, such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, DSL connections, cable modems and high-speed ISDN lines. Alternatively, devices 14 include any device capable of interconnecting to a network including a web-based phone or other web-based connectable equipment. Server 12 includes a database server 16 connected to a centralized database 18 containing business data, as described below in greater detail. Database 18 is sometimes referred to hereinafter as a data warehouse. In addition, server 12 is sometimes referred to hereinafter as a data mart. In one embodiment, database 18 is stored on database server 16 and can be accessed by potential users at one of user devices 14 by logging onto server 12 through one of user devices 14. In an alternative embodiment, database 18 is stored remotely from server 12.

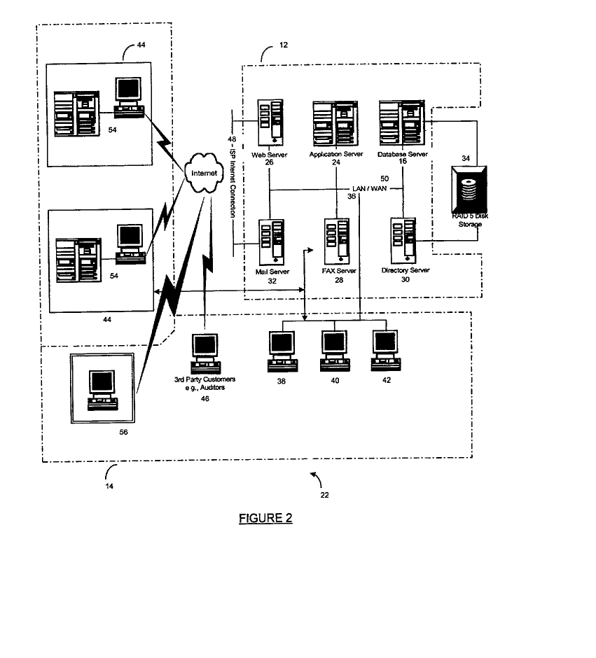

FIG. 2 is an expanded version block diagram of an exemplary embodiment of a server architecture of an Automated Customer Dashboard System (ACDS) 22. Components of ACDS 22, identical to components of ACDS 10 (shown in FIG. 1), are identified in FIG. 2 using the same reference numerals as used in FIG. 1. System 22 includes server 12 and user devices 14. Server 12 includes database server 16, an application server 24, a web server 26, a fax server 28, a directory server 30, and a mail server 32. A data storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Multiple workstations 38, 40, and 42 are illustrated to facilitate an understanding of the different types of functions that can be performed by individuals having access to LAN 36.

In another embodiment, server sub-system 12 is configured to be communicatively coupled to users and to customers via an ISP Internet connection 48. The communication in the exemplary embodiment is illustrated as being performed via the Internet, however, a wide area network (WAN) 50 can be used in other embodiments, i.e., the systems and processes are not limited to being practiced via the Internet. In addition, and rather than WAN 50, LAN 36 could be used in place of WAN 50.

In the exemplary embodiment, any authorized individual, such as a customer, having a computer workstation 52 can access server sub-system 12. One of user devices 14 includes a customer″s web-link 54 located at a remote location. Web-links 52 and 54 include computers, personal digital assistants, and Internet-enabled communication devices. In addition, web-links 52 and 54 are configured to communicate with server 12.

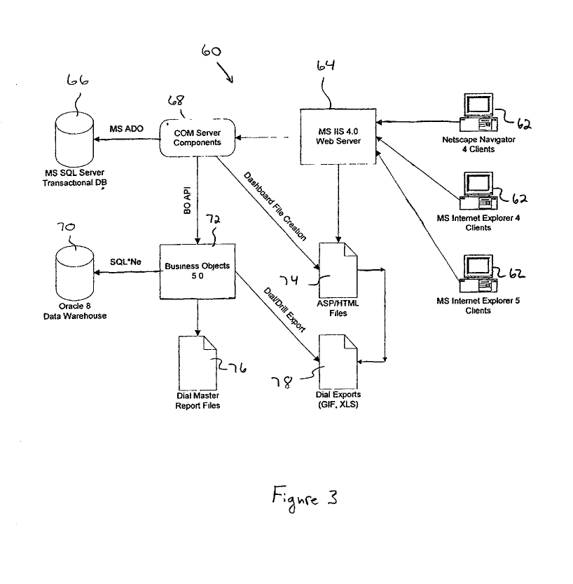

FIG. 3 is a schematic illustration of an exemplary system architecture 60 for a system such as system 10 (shown in FIG. 1) that is capable of running a customer dashboard application. A plurality of user terminals, or devices, 62 are connected to a web server 64 via a network. In one specific exemplary embodiment, the following commercially available hardware and software are utilized: Web Server platform Windows NT 4.0 SP5; Database Server platform Windows NT 4.0; Internet Information Server (IIS) 4.0; Microsoft Transaction Server (MTS); COM objects using VB 6.0 dIIs; Active Server Pages 3.0; Jscript 5.0; VBScript 5.0; and Database Oracle 8.0. The extranet site operates under IE 4.0 (or higher) and Netscape 4.0 (or higher).

Web server 64 is connected to an MS SQL server transactional database 66 through COM server components 68. In addition, web server 62 is connected to a data warehouse 70 through COM server components 68 and business objects 72.

In one embodiment, users access the customer dashboard application through a web site utilizing one of user terminals 62. Terminals 62 include a network-browser, for example, Netscape® by Netscape Communications Corporation, or Internet Explorer® by Microsoft Corporation. In one embodiment, the network-browser is one of Internet Explorer® 4.0 (or higher), or Netscape Navigator® 4.0 (or higher). The application web site includes Active Server page (ASP) documents 74 that generate HTML user interfaces as well as process user requests. In addition, business objects 72 is utilized to generate master report files 76 and dial export files 78. Request processing occurs using ASP VBScript that generally includes calls to custom-built COM server components 68 that perform a majority of the application functionality. COM server components 68 run on web server 62 using Microsoft Transaction Server. COM server components 68 also interact with Microsoft SQL Server database 66 which supports the transactional aspects of the application including user profiles, user interface configurations, user interface generation, and application security.

FIG. 4 illustrates a database configuration for a database such as database 18 shown in FIG. 1. Database 18 is coupled to several components within server 12. These components perform specific tasks to achieve the desired system functionality.

Server 12 includes a collection component 90 for collecting, updating and deleting information from users into database 18, a tracking component 92 for tracking information, a displaying component 94 to display information, a receiving component 96 to receive a specific query from client system 14, and an accessing component 98 to access database 18. Receiving component 96 is programmed for receiving a specific query for an electronic information report or dashboard from one of a plurality of users. Server 12 further includes a processing component 100 for searching and processing received queries for dashboards against data storage device 34 or server 12 containing a variety of information collected by collection component 90. An information fulfillment component 102, located in server 12, downloads the dashboards to the plurality of users. Information fulfillment component 102 downloads the information after the information is retrieved from data storage device 34 by a retrieving component 104. Retrieving component 104 further includes a display component 106 configured to download information to be displayed on a client system″s graphical user interface and a printing component 108 configured to print information.

In an exemplary embodiment, database 18 is divided into a Sales Section (SAS) 110, a Shipping Section (SHS) 112, a Product Receiving Section (PRS) 114, and a Customer Input Section (CIS) 116. Sections 110,112, 114, and 116 within database 18 are interconnected to update and retrieve the information as required. Each Section is further divided into several individualized sub-sections to store data in various different categories. In another embodiment, customized sections are developed using key evaluation metrics.

FIG. 5 is an exemplary embodiment of a flow diagram 120 for a computer network-based method for using ACDS 10 (shown in FIG. 1). Business information describing at least one of sales, shipping, product receiving, and customer inputs is received 122 and stored 124 in database 18 (shown in FIG. 1), such as a data warehouse. A user interface, such as a dashboard, is generated 126 and stored 128. In one embodiment, the dashboard is utilized to unify, filter, standardize, and expedite the reporting of the business information. As used hereinafter, a dashboard is a user interface that displays customer metrics (metrics defined by the customer). The dashboards enable a user to access, e.g., drill-down on, the customer metrics and examine particular aspects of the metrics. In one embodiment, the dashboards are utilized with quality initiatives.

Data from database 18 is processed in server 12 (shown in FIG. 1) and is used to populate 130 the generated dashboard. The processing in server 12 includes, but is not limited to, accessing, filtering, focusing, transforming into graphical representations, labeling, and validating. The populated dashboard is stored 132 so that authorized customers logged into ACDS 10 have the ability to display 134 the populated dashboard in a timely and consistent fashion. In one embodiment, the dashboard is stored on database 18. In another embodiment, the dashboard is stored on server 12. In yet another embodiment, the dashboard is stored in a distributed fashion on database 18, server 12 and on devices 14 (shown in FIG. 1). The dashboard is available to be displayed on user request.

FIG. 6 is a flow diagram of a method for creating a dashboard. As described in greater detail below, a user logs 142 into ACDS 10 (shown in FIG. 1) and selects 144 a create dashboard option. The user provides 146 a title for the dashboard. In one embodiment, the user provides 148 at least a portion of a customer name. In an alternative embodiment, the user provides 150 at least a portion of a customer number. At least one of the customer name and the customer number are used to identify the business information for the dashboard. The user selects 152 at least one filter, including, but not limited to, a region filter, a district filter, a business team filter, a plant filter, and a product family filter. The user then selects 154 at least one dial to install in dashboard. Each dial provides a particular parameter of business information in a graphic format. The dials can also be displayed in a numeric or a drilldown data spreadsheet format. In one embodiment, the dashboard includes up to six dials. The created dashboard is then stored 156 in a database, such as database 18 (shown in FIG. 1). Although a user creates a dashboard utilizing the above described process, viewing privileges are selectively granted to other customers and other users.

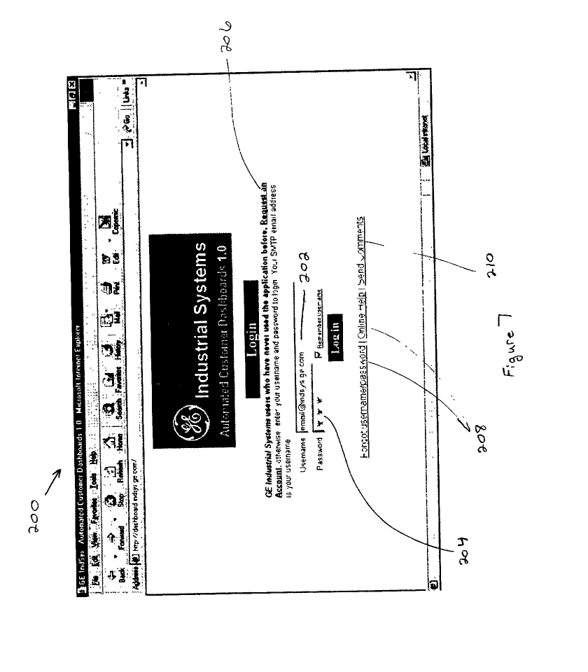

FIG. 7 is an exemplary embodiment of an interactive ACDS login user interface 200. Login user interface 200 facilitates access to ACDS by prompting the user to log into ACDS 10 (shown in FIG. 1). The user is prompted to enter a username 202 and a valid password 204 to gain access to ACDS 10. Options are available for new system users to request an account 206, to obtain help 208 or send comments 210.

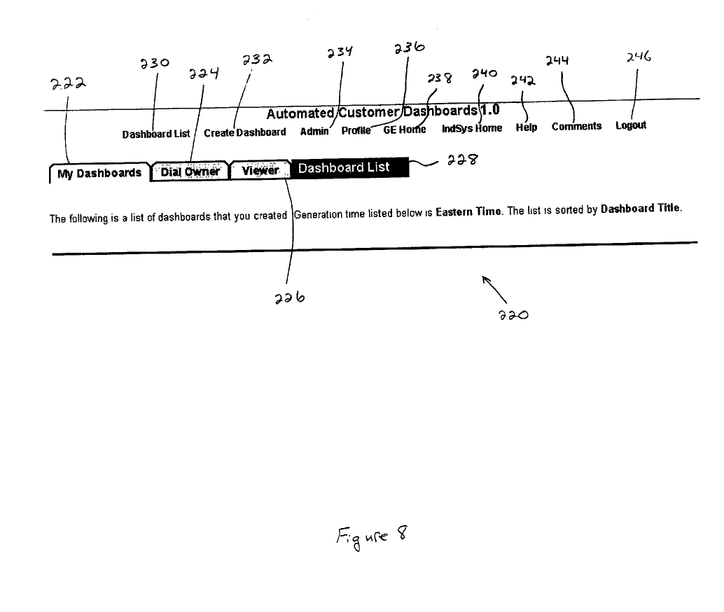

FIG. 8 is an exemplary embodiment of an ACDS main user interface 220. From ACDS main user interface 220 the user selects tabs to create or view dashboards. ACDS main user interface 220 includes a My Dashboards tab 222, a Dial Owner tab 224, a Viewer tab 226, and a dashboard list 228. Dashboard list 228 displays dashboards created by the user. ACDS main user interface 220 utilizes navigation buttons to guide the user into several sections. In an exemplary embodiment, the sections include, but are not limited to, a Dashboard List section 230, a Create Dashboard section 232, an Admin section 234, a Profile section 236, a company home section 238, a business home section 240, a Help section 242, a Comments section 244, and a Logout section 246. In one embodiment, additional section options are provided. Selection of one of tabs 222, 224, and 226 or one of sections 230, 232, 234, 236, 238, 240, 242, 244, and 246 provide more detailed user interfaces. Selection of Dial Owner tab 224 provides the user with a list of dials for which the user is designated the owner or the point of contact. Selection of Viewer tab 226 provides the user with a list of viewable dashboards. In another embodiment, ACDS main user interface 220, without selection of Viewer tab 226, initially provides a list of viewable dashboards.

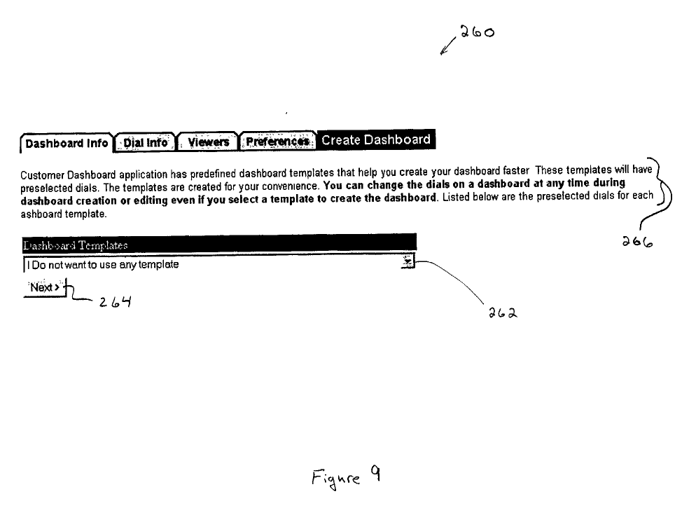

FIG. 9 is an exemplary embodiment of a Template Selection user interface 260 that facilitates selection of a dashboard template. A dashboard template drop down box 262 provides a list of potential templates that include pre-selected dials. Although the user is provided an opportunity to select a dashboard template, selection of a dashboard template is not required. Template Selection user interface 260 also includes a next button 264 utilized to display a next screen to the user. In the exemplary embodiment, an explanatory guide 266 is included in user interface 260 to assist the user in navigation through the network-site.

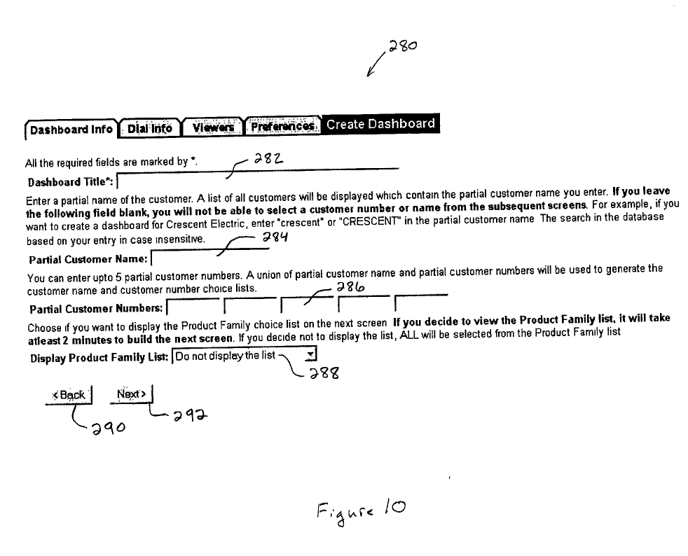

FIG. 10 is an exemplary embodiment of a Dashboard Information user interface 280 including a Dashboard Title field 282, a Partial Customer Name field 284, a Partial Customer Number field 286, and a Product Family List field 288. The user supplies the requested information in the appropriate information blocks and is provided a pull-down menu for Display Product Family List 288. User interface 280 also includes a back button 290 and a next button 292 to facilitate navigation through the site.

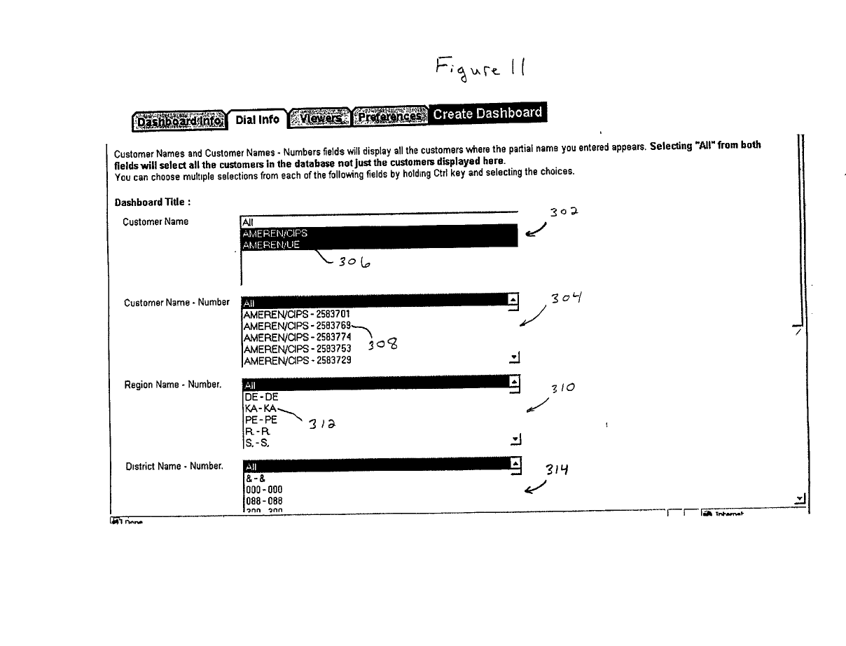

FIG. 11 is an exemplary embodiment of a Customer List user interface 300 including a Customer Names pull-down list 302 and a Customer Name-numbers pull-down list 304. At least one listing entry of a Customer Name 306 and a Customer Name-number 308 is selected from the appropriate pull-down lists to specify the information to be used to generate the dashboard. In one embodiment, multiple Customer Names 306 and multiple Customer Name-numbers 308 are selected. Customer List user interface 300 also shows a Region Name-Number pull-down list 310 including a listing of potential regions 312. Customer List user interface 300 further includes a partial listing of a District Name Number pull-down list 314.

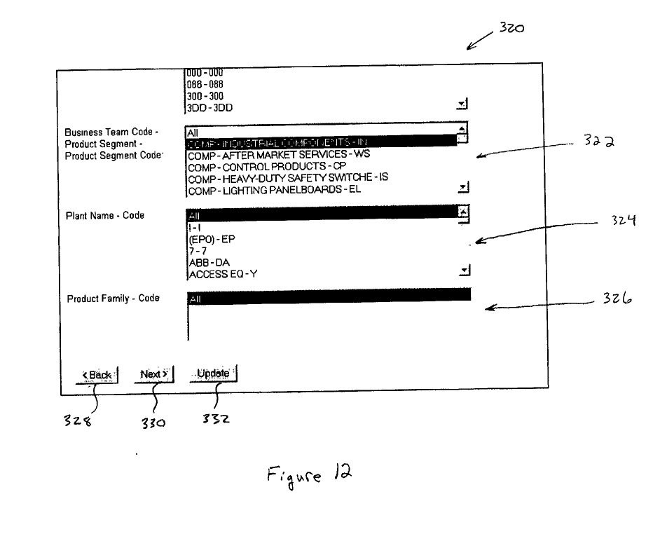

FIG. 12 is an exemplary embodiment of a screen shot 320 which is a continuation of Customer List user interface 300. Screen shot 320 includes additional filters such as a Business Team Code-Product Segment-Product Segment Code pull-down list 322, a Plant Name-Code pull-down list 324, and a Product Family-Code pull-down list 326. Selection of additional filters allows dashboards to be narrowed with respect to scope. However, selection of additional filters is not required. Use of a standard navigation Next button 328 finalizes the parameter selection. Use of an Update button 330 facilitates saving intermediate selections. A Back button 332 facilitates modifications of previously displayed pull-down lists.

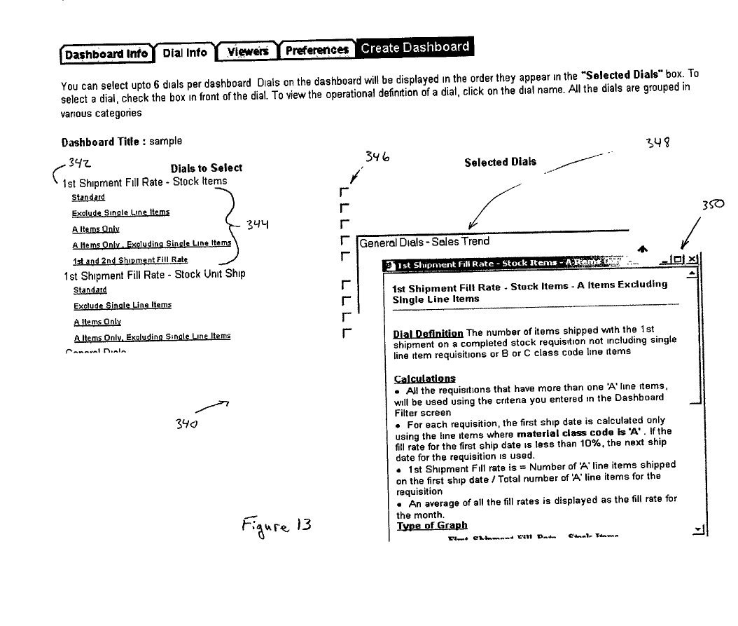

FIG. 13 is an exemplary embodiment of a Dial Info user interface 340. Dial Info user interface 340 includes a dial list 342 identifying dials by a dial name 324. Dial list 342 shows dials that are available for inclusion in the dashboard. The dials are included in the dashboard by marking selecting one of check boxes 346 adjacent dial name 344. If a dashboard template was previously selected, ACDS 10 (shown in FIG. 1) installs pre-selected dials in the dashboard. In one embodiment, dials may be removed from the dashboard. In an alternative embodiment, additional dials may be added to the dashboard. Dial names 344 are displayed in a selected dial field 348 when an associated dial is selected for the dashboard. In one embodiment, each dial name 344 is linked to an ACDS popup window 350 which provides explanatory information relevant to the selected dial.

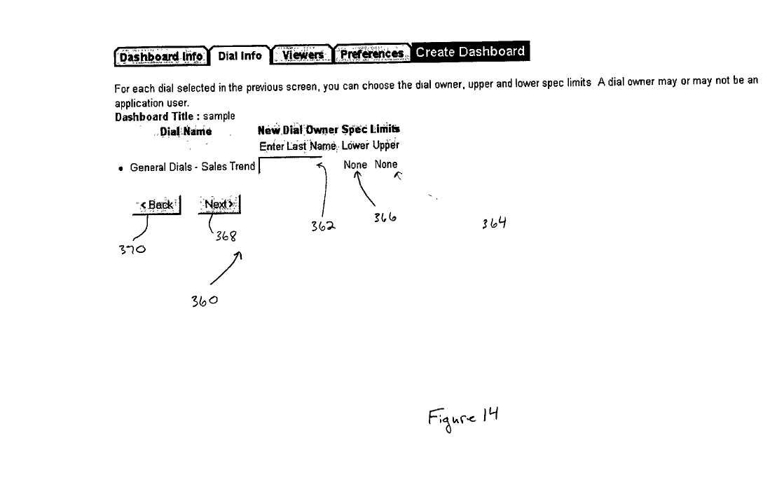

In one embodiment, the dials include, but are not limited to, a 1 st Shipment Fill Rate (Stock)—Standard report, a 1 st Shipment Fill Rate (Stock)—Exclude Single Line Items report, a 1 st Shipment Fill Rate (Stock)—A Items Only report, a 1 st Shipment Fill Rate (Stock)—A Items Only—Exclude Single Line Items report, a 1 st Shipment Fill Rate (Stock Unit Ship)—Standard report, a 1 st Shipment Fill Rate (Stock Unit Ship)—Exclude Single Line Items report, a 1 st Shipment Fill Rate (Stock Unit Ship)—A Items Only report, a 1 st Shipment Fill Rate (Stock Unit Ship)—A Items Only—Exclude Items report, a Number of Days to 1 st Shipment—Stock Items report, a Number of Shipments Per Order—Stock Items report, a % Lines Complete in 10 Days—Stock Items report, an Average Days To Complete Order—Stock Items report, a RGA As % Of Sales report, a Transactional Quality As % Of Sales report, an Order Placement Profile & Order Entry Productivity report, a Requests Met—Stock & Drop Ship Items report, a Requests Met—Stock Only Items report, a Requests Met—Drop Ship Items Only report, a Promises Kept—Stock & Drop Ship Items report, a Promises Kept—Stock Items Only report, a Promises Kept—Drop Ship Items Only report, a Product Quality—Percentage report, a Product Quality—DPMO report, a Product Quality—Total RMAs report, a Product Quality—Total RMA Item Quantity report, a Product Quality—RMAs Issued vs. Line Items Shipped report, a Product Quality—RMAs Issued vs. Orders report, a Product Quality—RMAs vs. Total Line Item Quantity report, and a Sales YTM Trend report. FIG. 14 is an exemplary embodiment of a Dial Owner user interface 360 including a dial owner input field 362, an upper spec limit field 364, and a lower spec limit field 366. In one embodiment, a dial owner name 368 (not shown) is inserted into dial owner input field 362, identifying the point of contact for the dial. In an alternative embodiment, the dial owner name is not required. In a further embodiment, information is also provided to upper spec limit field 364 and lower spec limit field 366. Spec limits facilitate the user filtering data to minimize skewing of the dial due to outlying data. Selection of a Next button 368 completes the Dial owner user interface 360. Selection of a back button 370 displays a previous user interface to the user.

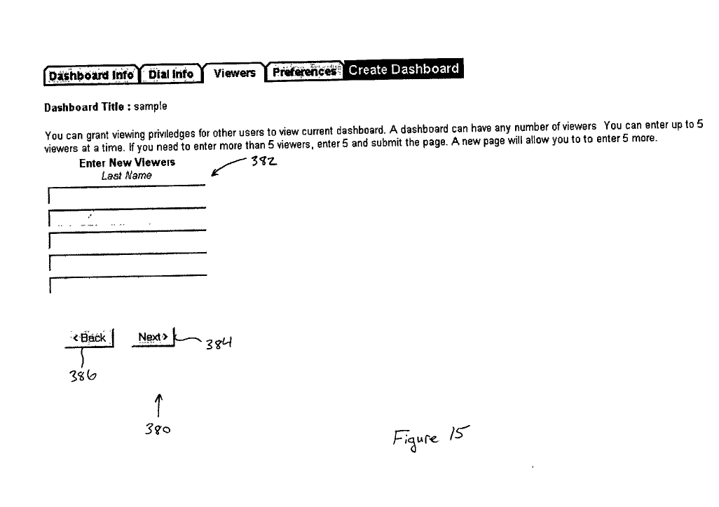

FIG. 15 is an exemplary embodiment of a Viewer user interface 380 including a New Viewer field 382. At least one name (not shown) of other users and customers are listed to facilitate granting those listed dashboard viewing privileges. In one embodiment, any number of other users and customers can be authorized viewing privileges. In an alternative embodiment, up to five names are entered in New Viewer field 382. Operation of a Next button 384 facilitates granting viewing privileges to users and customers listed in New Viewer field 382 and generates a new Viewer field 382 for entry of additional names. Selection of Next button 384 with fewer than five names entered in New Viewer field 382 completes the View user interface 380. Selection of a back button 386 displays a previous user interface to the user.

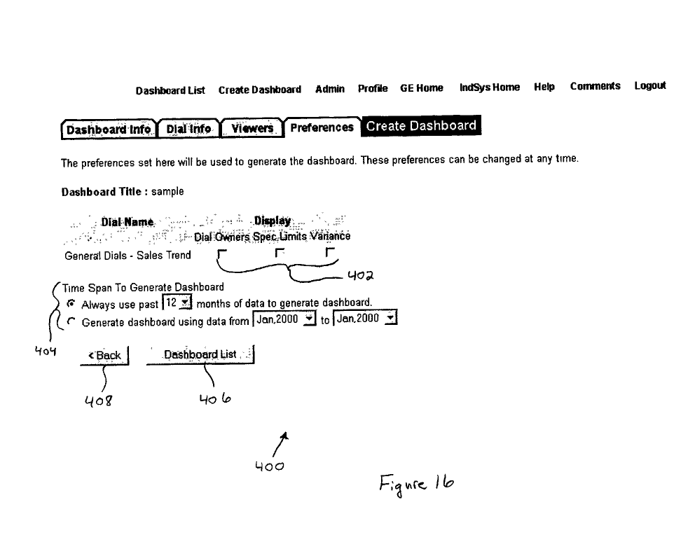

FIG. 16 is an exemplary embodiment of a Preferences user interface 400 including a list of dials on the dashboard. A plurality of display options fields 402 are included for each dial on the dashboard. In one embodiment, some display options fields 402 can be modified by the user, allowing additional information to be included with the dial. In an alternative embodiment, some display option fields 402 are pre-selected by ACDS 10 (shown in FIG. 1). Preferences user interface 400 also includes a time span input field 404, which facilitates user specification of the time period covered by the dashboard. A Dashboard List Button 406 completes the creation of the dashboard and returns the user to the ACDS main user interface. The created dashboard is stored in ACDS 10. Selection of a back button 408 displays a previous user interface to the user.

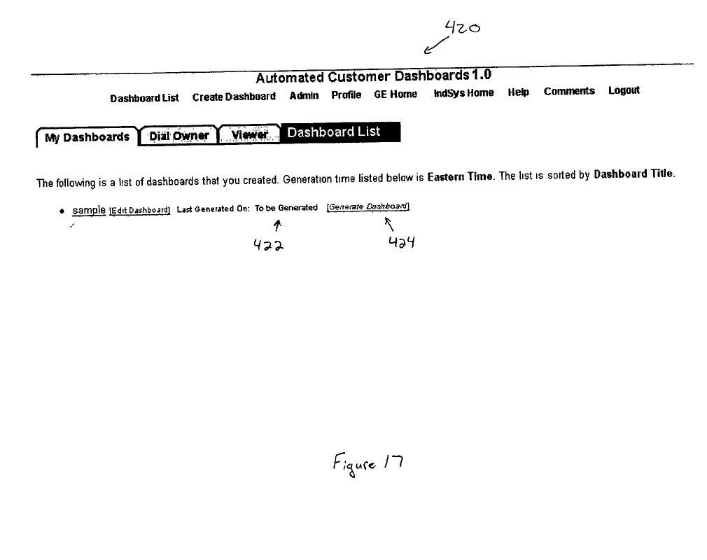

FIG. 17 is an exemplary embodiment of an ACDS main user interface including a newly created dashboard, as depicted in screen shot 420. The dashboard has not yet been populated with information, as depicted in screen shot 420. A Generate Dashboard section 422 facilitates population of the dashboard by ACDS 10 (shown in FIG. 1) using data from database 18 (shown in FIG. 1). Information from database 18 is narrowed by the prior selections, such as from Customer Names pull-down list 302 (shown in FIG. 11), customer name-number pull-down list 304 (shown in FIG. 11), Business Team Code-Product Segment-Product Segment Code pull-down list 322 (shown in FIG. 12), Plant Name-Code pull-down list 324 (shown in FIG. 12), and Product Family-Code pull-down list 326 (shown in FIG. 12), as applicable. In another embodiment, other parameters are provided to narrow the data required from database 18.

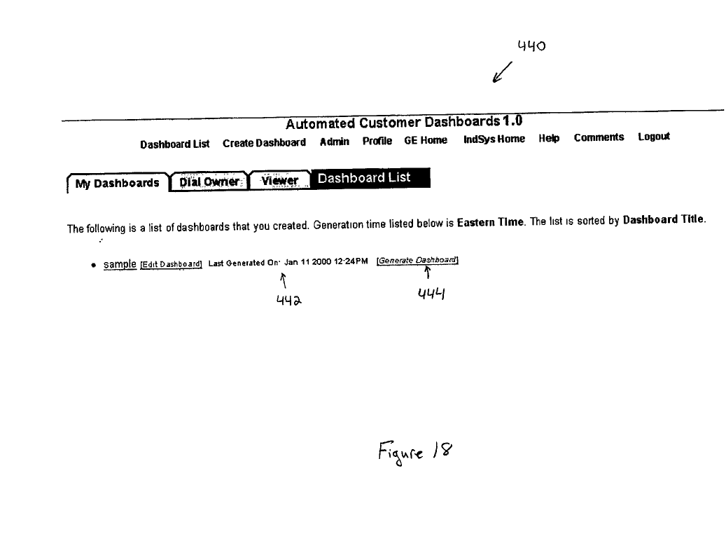

FIG. 18 is an exemplary embodiment of an ACDS main user interface after generation of a dashboard by ACDS 10 (shown in FIG. 1), as depicted in screen shot 440. A Last Generated On area 442 depicts a date-time provided by ACDS 10 displaying the most recent generation of the dashboard. In one embodiment, the dashboard is regenerated on user command by selection of Generate Dashboard section 444. In another embodiment, the dashboard is routinely regenerated by ACDS 10 on a predetermined schedule.

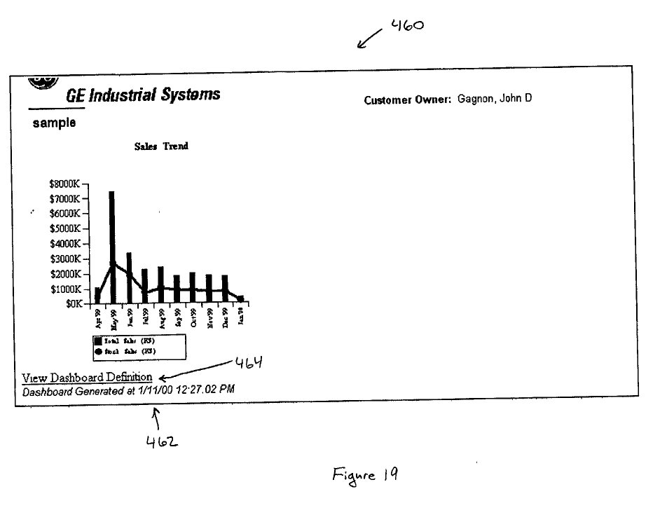

FIG. 19 is an exemplary embodiment of a dashboard including one dial, as depicted in screen shot 460. In one embodiment, the dashboard includes a Dashboard Generated Date-time area 462 and a Dashboard Definition section 464. The date and time when the dashboard was last generated is provided by ACDS 10 (shown in FIG. 1) in Dashboard Generated Date-time area 462. Dashboard Definition section 464 can be selected by the user to provide a review of parameters included in the generation of the dashboard. In one embodiment the parameters include, but are not limited to, customer name-number, region, factory, and product family. The dial is depicted in a bar chart format. In one embodiment, the dial display format can be selected from a plurality of chart types, including, but not limited to line chart, pie chart, XY-scatter chart, 3D-area chart, 3D-line chart, and 3D-pie chart.

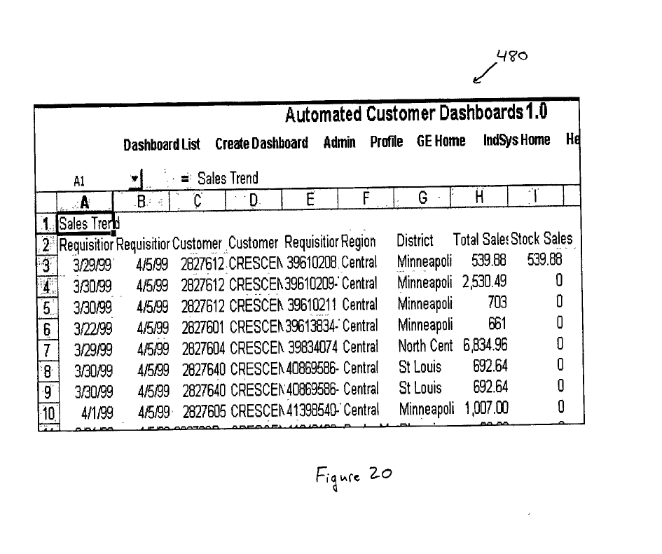

FIG. 20 is a drilldown data display user interface of a dial, as depicted in screen shot 480. In one embodiment, drilldown data display of the dial can be selected by selecting the dial from the appropriate dashboard. Screen shot 480 displays the business information in a spreadsheet format.

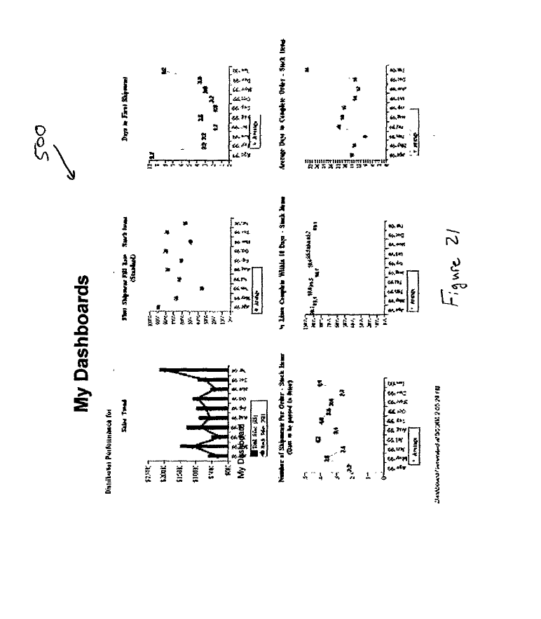

FIG. 21 is an exemplary embodiment of a screen shot 500 illustrating a dashboard including six dials. ACDS 10 (shown in FIG. 1) facilitates the creation of an electronic information report, or dashboard, which ACDS 10 generates with information filtered from database 18 (shown in FIG. 1). The dashboard displays the business information for users and customers and includes at least one dial which displays a predetermined parameter of business information. In alternative embodiments, the dials pertain to after market support, Mean Time to Repair (MTTR), customer call center metrics, warranty information and repair information.

In use, a user or customer accesses ACDS 10 via a device 14 communicating with server 12. Multiple users and customers can access ACDS 10 simultaneously. The user or customer logs into ACDS 10 from an interactive ACDS login user interface. In one embodiment, when the user or customer successfully logs into ACDS 10, an ACDS main user interface is displayed, including a list of dashboards created. From the ACDS main user interface, the user or customer selects a Dashboard List section to display a list of viewable dashboards. In another embodiment, the ACDS main user interface displays a list of viewable dashboards without operator action. In a further embodiment, the ACDS main user interface displays both a list of viewable dashboards and a list of dashboards created without operator action. Viewing of the dashboards is available only to users and customers that have been granted viewing privileges. Additionally, not all users and customers have been granted rights to create dashboards. Thus availability of each dashboard is selectively controlled and restricted. The users and customers select any dashboard from the list of viewable dashboards. When a dashboard is selected, ACDS 10 provides the most recently generated dashboard. The dashboard includes selected dials including focused business information. A copy of the dashboard can be printed from device 14.

In one embodiment, selecting a My Dashboard tab from the ACDS main user interface allows the user to review a list of dashboards previously created. When the dashboard is selected from the My Dashboard tab, the dashboard can be edited, including modification of parameters established during creation of the dashboard. At least some of the Dials can be removed and other dials can be added to the dashboard. Additional names can be added to the

New Viewer field and names can be removed from the New Viewer field.

ACDS 10 provides global access to performance information and current trends of specific business information to customers and managers. ACDS facilitates summarizing, retrieving, displaying, and sharing business information. The dashboard offers users and customers an overview of a range of business information, as well as the ability to examine, or “drill down” into the details.

ACDS also allows users and customers the opportunity to share business information in a consistent and timely fashion. Dashboard screen shots can be download as stand files, viewable by standard network-browsers. Furthermore, the information in the dashboard is generated frequently, providing up-to-date information for effective management. Multiple users and customers can simultaneously access the same information, facilitating meaningful teleconferencing.

While the invention has been described in terms of various specific embodiments, those skilled in the art will recognize that the invention can be practiced with modification within the spirit and scope of the claims.

1. A method of communicating business information using a network-based system including at least one server coupled to a database and at least one device, said method comprising:
creating a plurality of dashboards;
storing the dashboards in the database;
populating the dashboards using information from the database; and
providing the dashboards to a user through the device.

2. A method according to claim 1 wherein providing the dashboards comprises providing the same dashboard to a plurality of users, simultaneously.

3. A method according to claim 1 wherein populating the dashboards comprises populating the dashboard with updated information from the database.

4. A method according to claim 1 wherein creating a plurality of dashboards further comprises selecting filtering parameters.

5. A method according to claim 1 wherein creating a plurality of dashboards further comprises selecting at least one dial for the dashboard.

6. A method according to claim 5 wherein selecting at least one dial comprises selecting a dial that displays one of a 1 st Shipment Fill Rate (Stock)—Standard report, a 1 st Shipment Fill Rate (Stock)—Exclude Single Line Items report, a 1 st Shipment Fill Rate (Stock)—A Items Only report, a 1 st Shipment Fill Rate (Stock)—A Items Only—Exclude Single Line Items report, a 1 st Shipment Fill Rate (Stock Unit Ship)—Standard report, a 1 st Shipment Fill Rate (Stock Unit Ship)—Exclude Single Line Items report, a 1 st Shipment Fill Rate (Stock Unit Ship)—A Items Only report, a 1 st Shipment Fill Rate (Stock Unit Ship)—A Items Only—Exclude Items report, a Number of Days to 1 st Shipment—Stock Items report, a Number of Shipments Per Order—Stock Items report, a % Lines Complete in 10 Days—Stock Items report, an Average Days To Complete Order—Stock Items report, a RGA As % Of Sales report, a Transactional Quality As % Of Sales report, an Order Placement Profile & Order Entry Productivity report, a Requests Met—Stock & Drop Ship Items report, a Requests Met—Stock Only Items report, a Requests Met—Drop Ship Items Only report, a Promises Kept—Stock & Drop Ship Items report, a Promises Kept—Stock Items Only report, a Promises Kept—Drop Ship Items Only report, a Product Quality—Percentage report, a Product Quality—DPMO report, a Product Quality—Total RMAs report, a Product Quality—Total RMA Item Quantity report, a Product Quality—RMAs Issued vs. Line Items Shipped report, a Product Quality—RMAs Issued vs. Orders report, a Product Quality—RMAs vs. Total Line Item Quantity report, and a Sales YTM Trend report.

7. A method according to claim 5 wherein selecting at least one dial comprises selecting a dial owner.

8. A method according to claim 5 wherein selecting at least one dial comprises selecting a upper spec limit and a lower spec limit for the dial.

9. A method according to claim 1 wherein creating a plurality of dashboards comprises selecting a time span for the information used to generate the dashboard.

10. A method according to claim 1 wherein creating a plurality of dashboards comprises granting viewing privileges for at least one user.

11. A system for communicating business information, said system comprising:
at least one device;
at least one server configured to receive business information, store the business information and provide the business information;
a network connecting said at least one server to said at least one device; said server configured to generate at least one dashboard using the business information, the dashboard available through said network for display on said device.

12. The system of claim 11 wherein the at least one dashboard is stored on said at least one server.

13. The system of claim 11 wherein the dashboard comprises at least one dial.

14. The system of claim 13 wherein each dial comprises a display of one of at least one of a 1 st Shipment Fill Rate (Stock)—Standard report, a 1 st Shipment Fill Rate (Stock)—Exclude Single Line Items report, a 1 st Shipment Fill Rate (Stock)—A Items Only report, a 1 st Shipment Fill Rate (Stock)—A Items Only—Exclude Single Line Items report, a 1 st Shipment Fill Rate (Stock Unit Ship)—Standard report, a 1 st Shipment Fill Rate (Stock Unit Ship)—Exclude Single Line Items report, a 1 st Shipment Fill Rate (Stock Unit Ship)—A Items Only report, a 1 st Shipment Fill Rate (Stock Unit Ship)—A Items Only—Exclude Items report, a Number of Days to 1 st Shipment—Stock Items report, a Number of Shipments Per Order—Stock Items report, a % Lines Complete in 10 Days—Stock Items report, an Average Days To Complete Order—Stock Items report, a RGA As % Of Sales report, a Transactional Quality As % Of Sales report, an Order Placement Profile & Order Entry Productivity report, a Requests Met—Stock & Drop Ship Items report, a Requests Met—Stock Only Items report, a Requests Met—Drop Ship Items Only report, a Promises Kept—Stock & Drop Ship Items report, a Promises Kept—Stock Items Only report, a Promises Kept—Drop Ship Items Only report, a Product Quality—Percentage report, a Product Quality—DPMO report, a Product Quality—Total RMAs report, a Product Quality Total RMA Item Quantity report, a Product Quality—RMAs Issued vs. Line Items Shipped report, a Product Quality—RMAs Issued vs. Orders report, a Product Quality—RMAs vs. Total Line Item Quantity report, and a Sales YTM Trend report.

15. The system of claim 13 wherein the dial comprises a graphic display of business information.

16. The system of claim 13 wherein the dial comprises a drilldown data display of business information.

17. The system of claim 11 wherein said at least one server regenerates said dashboards on at least one of a predetermined schedule and on command.

18. The system of claim 11 wherein the at least one dashboard is selectively available through said network, said network is at least one of the Internet, an intranet, a wide area network and a local area network.

19. The system of claim 11 wherein the at least one dashboard includes business information within a specific time span.

20. The system of claim 11 wherein said at least one dashboard provides business information based on selectable parameters.

21. A system for communicating business information, said system comprising:
at least one device;
at least one server configured to receive business information, store the business information and provide the business information;
a network connecting said at least one server to said at least one device; and
at least one dashboard comprising at least one dial comprising a graphic display of the business information and a drilldown data display, said dashboard generated by said server using the business information, said dashboard stored on said server after generation, said dashboard selectively available through said network for display on said device.

22. A computer program embodied on a computer readable medium for managing business information, said program comprising a code segment that receives business information and then:
maintains a database by adding, deleting and updating business information;
generates at least one dashboard based on the received business information; and
provides consistent dashboards to users.

23. The computer program as recited in claim 22 further comprising a code segment that provides at least one of an option to filter business information based on at least one of a Customer Names pull-down list, a Customer Name-numbers pull-down list, a Region Name-Number pull-down list, a Business Team Code-Product Segment-Product Segment Code pull-down list, a Plant Name-Code pull-down list, and a Product Family-Code pull-down list.

24. The computer program as recited in claim 22 further includes a code segment that generates a display of at least one of a 1 st Shipment Fill Rate (Stock)—Standard report, a 1 st Shipment Fill Rate (Stock)—Exclude Single Line Items report, a 1 st Shipment Fill Rate (Stock)—A Items Only report, a 1 st Shipment Fill Rate (Stock)—A Items Only—Exclude Single Line Items report, a 1 st Shipment Fill Rate (Stock Unit Ship)—Standard report, a 1 st Shipment Fill Rate (Stock Unit Ship)—Exclude Single Line Items report, a 1 st Shipment Fill Rate (Stock Unit Ship)—A Items Only report, a 1 st Shipment Fill Rate (Stock Unit Ship)—A Items Only—Exclude Items report, a Number of Days to 1 st Shipment—Stock Items report, a Number of Shipments Per Order—Stock Items report, a % Lines Complete in 10 Days—Stock Items report, an Average Days To Complete Order—Stock Items report, a RGA As % Of Sales report, a Transactional Quality As % Of Sales report, an Order Placement Profile & Order Entry Productivity report, a Requests Met—Stock & Drop Ship Items report, a Requests Met—Stock Only Items report, a Requests Met—Drop Ship Items Only report, a Promises Kept—Stock & Drop Ship Items report, a Promises Kept—Stock Items Only report, a Promises Kept—Drop Ship Items Only report, a Product Quality Percentage report, a Product Quality—DPMO report, a Product Quality—Total RMAs report, a Product Quality—Total RMA Item Quantity report, a Product Quality—RMAs Issued vs. Line Items Shipped report, a Product Quality—RMAs Issued vs. Orders report, a Product Quality—RMAs vs. Total Line Item Quantity report, and a Sales YTM Trend report.

25. The computer program as recited in claim 22 further comprising a code segment that displays each dashboard in a standardized format.

26. The computer program as recited in claim 22 further comprising:
a code segment that accesses the database;
a code segment that searches the database regarding the specific inquiry;
a code segment that retrieves information from the database; and
a code segment that causes the retrieved information to be displayed on the client system.

27. The computer program as recited in claim 22 and further comprising a code segment that monitors the security of the system by restricting access to authorized individuals.
